(19) United States
(12) Patent Application Publication
(10) Pub. No.: US 2018/0007831 A1
(43) Pub. Date: Jan. 11, 2018

(54) Crop Residue Spreader

(71) Applicant: CNH Industrial America LLC, New Holland, PA (US)

(72) Inventors: Stefaan Ballegeer, Beernem (BE); Stefaan Desmet, Vosselare (BE); Frank R.G. Duquesne, Zwevegem (BE); Eli Maes, Snaaskerke (BE); Tom N.N. Somers, Aalter (BE); Peter Hollevoet, Zedelgem (BE)

(21) Appl. No.: 15/644,182

(22) Filed: Jul. 7, 2017

(30) Foreign Application Priority Data
Jul. 8, 2016 (BE) 2016/5571

(51) Int. Cl. A01D 41/12; A01F 12/40; A01F 12/30; A01D 41/00; A01F 12/00

(52) U.S. Cl. CPC A01D 41/1243; A01F 12/40; A01F 12/30; A01F 12/00; A01D 41/00

(57) ABSTRACT

An agricultural harvester with crop residue spreaders distributing crop residue laterally. Each crop residue spreader has a plurality of radially extending bats rotatable within a housing for directing residue from an axially directed inlet radially outward through an outer outlet. The housing has an outer wall with a height that increases axially in a uniform fashion around the periphery to minimize if not eliminate recirculation of residue to the inlet.

### CROSS REFERENCE TO RELATED APPLICATION

This application claims priority to Belgian Application No. 2016/5571 filed Jul. 8, 2016, the contents of which are incorporated herein by reference.

### FIELD OF THE INVENTION

The present invention relates to agricultural harvesters such as combines, and, more particularly, to crop residue systems used in such combines.

### BACKGROUND OF THE INVENTION

An agricultural harvester known as a “combine” is historically termed such because it combines multiple harvesting functions with a single harvesting unit, such as picking, threshing, separating and cleaning. A combine includes a header which removes the crop from a field, and a feeder housing which transports the crop matter into a threshing rotor. The threshing rotor rotates within a perforated housing, which may be in the form of adjustable concaves and performs a threshing operation on the crop to remove the grain. Once the grain is threshed, it falls through perforations in the concaves onto a grain pan. From the grain pan, the grain is cleaned using a cleaning system, and is then transported to a grain tank onboard the combine. A cleaning fan blows air through the sieves to discharge straw, chaff and other debris toward the rear of the combine.

During the process of harvesting, crop material other than grain (MOG) is intended to be expelled from the combine. This material is usually derived from one of two areas, the threshing rotor or the cleaning system. The material expelled from the threshing rotor is generally referred to as straw and the material expelled from the cleaning system is generally referred to as chaff. This crop residue can be dealt with in several ways, generally categorized as spread and windrowed.

Spread refers to using a mechanical device to distribute the straw and/or chaff evenly across the width of the combine header cut width. This spread material is usually chopped to as short a length as possible so that when it is spread it will break down as quickly as possible and not interfere with tillage or seeding operations.

The residue spreader is usually formed from a rotor driven generally about a vertical axis and having a plurality of vanes or bats that propel residue entering from an axially directed inlet outward in a tangential stream so as to distribute residue continuously across a relatively wide swath. An example of such an arrangement is illustrated in U.S. Pat. No. 4,917,652. The residue comes through a vertical inlet and, as the bats rotate about the axis, the residue is propelled towards the tangential outlet. One of the issues occurring with prior art spreaders is that material towards the end of its path may recirculate back into the inlet and diminish the efficiency of the rotating bats. The recirculation of the residue to the inlet impedes the action of sucking material into the inlet of the crop residue spreader.

Accordingly, what is needed in the art is an efficient crop residue spreader that minimizes, if not eliminates recirculation of residue, for managing the distribution of crop residue in a combine.

### SUMMARY OF THE INVENTION

The present invention provides apparatus for crop residue management having efficiently directed crop residue.

The invention, in one form, is a crop residue spreader having a plurality of radially extending bats mounted for rotational movement about an axis A. A housing surrounds the bats and has an inlet for residue adjacent axis A and a radially outward outlet. The housing has an axial height that increases around its periphery up to the outlet.

In another form, the invention is an agricultural combine including a crop processing apparatus separating crop material from crop residue containing straw and chaff and for discharging crop residue therefrom in a stream. A crop residue spreader receives the stream from the crop processing apparatus and has a plurality of radially extending bats mounted for rotational movement about an axis A. A housing surrounds the bats and has an inlet for residue adjacent axis A and a radially outward outlet. The housing has an axial height that increases around its periphery up to the outlet.

One advantage of the present invention is that recirculation of crop residue around the inlet of a residue spreader is minimized if not eliminated.

Another advantage of the present invention is that crop residue is more efficiently spread.

Still another advantage is that the instance of clogging in the inlet is minimized, if not eliminated.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of an embodiment of an agricultural harvester in the form of a combine which may include a crop residue spreader of the present invention;

FIG. 2 is a plan view of a crop residue spreader incorporated in the agricultural harvester of FIG. 1 showing a position in which crop residue is distributed laterally; and,

FIG. 3 is a perspective view of the crop residue spreader of FIG. 2.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

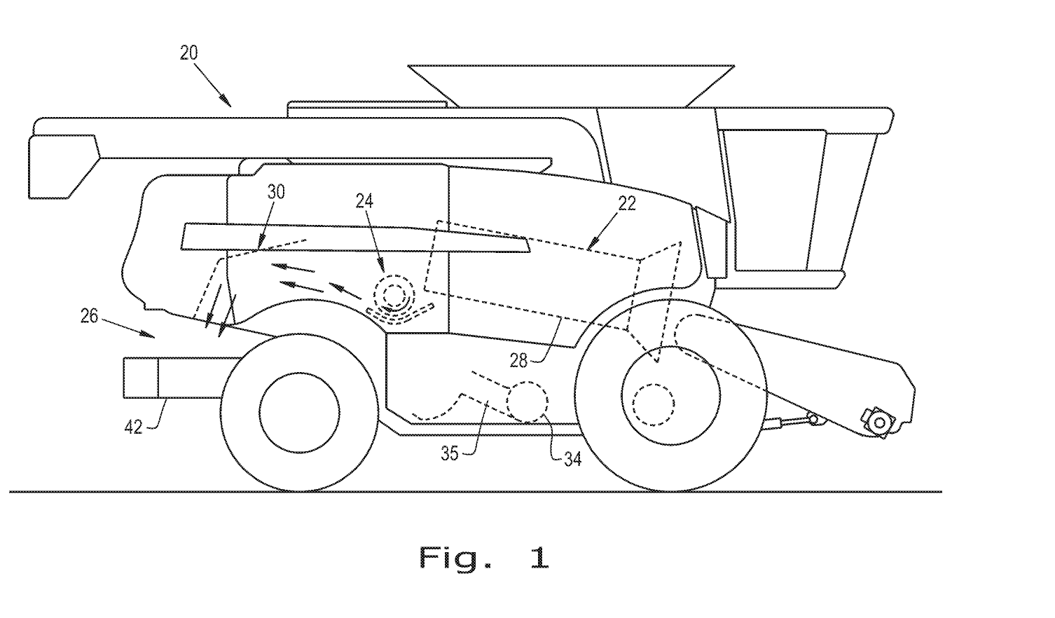

FIG. 1 shows an agricultural combine 20 which includes the usual harvesting apparatus (not all of which is shown to facilitate an understanding of the invention). An axially oriented crop processing system 22 receives harvested crop and a crop residue treatment and distribution system 24 with a crop residue spreader 26 is positioned at the aft end of combine 20. The crop residue treatment and distribution system 24 includes a cylindrical threshing rotor 28 that conveys a flow of crop material in a helical flow path. As the crop material is moved through the processing apparatus 22, the desired crop such as grain or other material is loosened and separated from crop residue such as husk and pods in a cleaning system located beneath the threshing rotor 28. The crop processing system 22 includes a blower 34, schematically depicted, to aid in the separation of the desired crop from the crop residue. The blower 34 has a duct 35 extending aft in the combine 20 towards the cleaning system and the crop residue treatment and distribution system 24.

The crop residue spreader system includes a duct 30 that directs the crop residue stream towards a pair of crop residue spreaders 42.

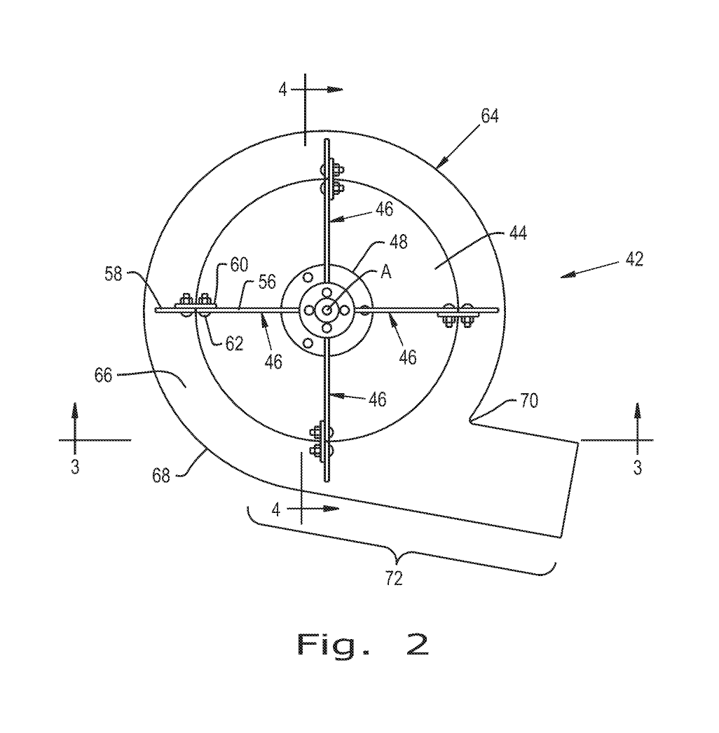

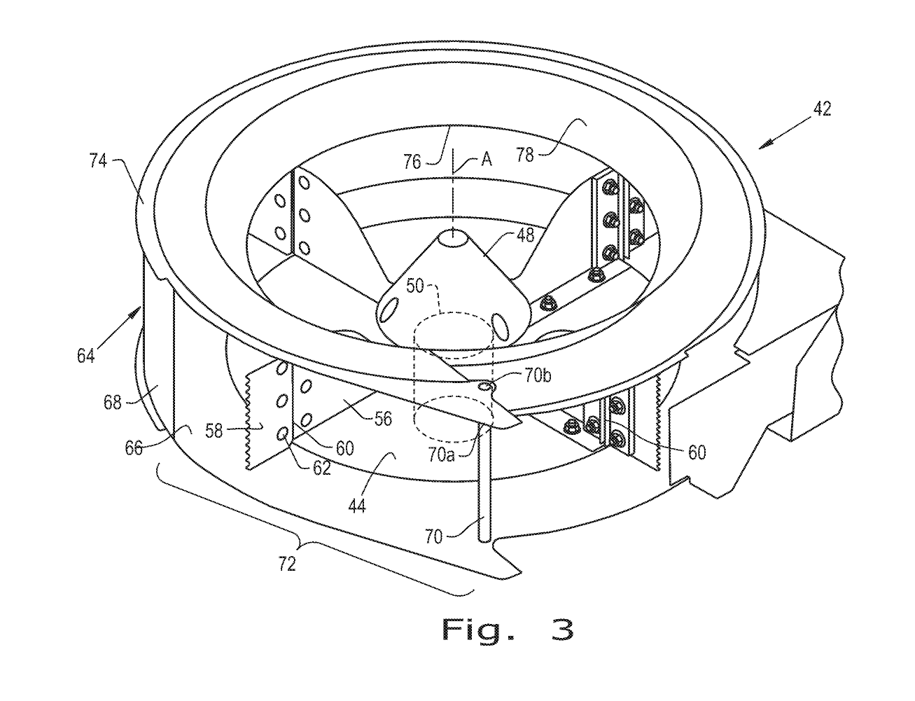

Referring to FIGS. 2-3, crop residue spreaders 42 include side-by-side disks 44 journaled for rotation about axis A and positioned laterally with respect to one another when in the spreading configuration. Disks 44 have a plurality of bats 46 that act like vanes to positively direct crop residue in a lateral direction. A cone 48 extends vertically upward from each disk 44 and directs residue from a direction along axis A radially outward so it is directed by the bats 46. A motor 50 is connected to each disk 44 through a motor output shaft (not shown) causing the disks 44 to rotate as needed. Although motor 50 is illustrated as hydraulic, it may be in any one of a number of forms including mechanical interconnection to a remotely positioned motor. Rotation of disks 44 is set up so that when viewed from above and looking towards the front of the combine 20, the right side disk (illustrated) rotates counterclockwise and the left disk rotates clockwise so that they propel crop residue between them aft and around and laterally.

FIGS. 2 and 3 show the crop residue spreader on the right of, and in the rear portion of, a combine. Each bat 46 includes an inner portion 56 secured to disk 44 and an outer portion 58 connected to the inner portion through a flexible connector 60 and suitable fasteners 62. The flexible connector 60 enables better accommodation of varying quantities of residue passing through the crop residue spreader device 42.

The crop residue spreader 42 has a housing 64 including a floor 66 underneath the disk 44 and forming the structural base for the housing 64. An outer wall 68 extends around the periphery of the bats 46 to form a straight sided curved outer wall. As discussed below, the width of the housing 64 may increase from a minimum height at reference point 70 and continuously increases to a maximum height around the periphery of the housing 64. An outlet section 72 is connected to outer wall 68 and provides a closed tangentially directed outlet for residue. An upper housing wall 74 connects with the outer wall 68 and has a distance from the floor 66 in a direction parallel to axis A (housing width) that increases continuously from a minimum point at reference point 70 adjacent the outlet section 72 around the periphery of housing 68 to the outlet section 72. As can be seen in FIG. 2 and FIG. 3, the reference point 70 is located at the downstream end of the opening in the housing 68, which opening forms the start of the outlet section 72. Downstream and upstream are therein used as relative terms referring to the direction of rotation of the bats 46 and the residue propelled thereby. FIG. 2 and FIG. 3 show the right side spreader unit 42 wherein the bats are rotated counterclockwise (seen from above). For a rotating bat 46 passing the opening in the housing 68, the reference point 70 is adjacent the end of the opening. The upper housing wall 74 has a circular inlet 76 with a tapered section 78 angled in the direction of flow into the interior of housing 64.

With particular reference to FIG. 3, the minimum dimension of outer wall 68 is at reference point 70A directly behind the opening (seen from the tip of a rotating bat 46) and, during a full rotation of the bat 46, continuously increases to its maximum at reference point 70B. Thus, it is seen that the housing 68, which surrounds the bats 46, has an increasing width. With reference to FIG. 2, a radial distance of the outer wall 68 from the axis A increases continuously around the periphery of housing 64 to a maximum adjacent the outlet section 72. As a result, the flow path for residue expands as the residue is directed around the periphery by the bats 46. It is to be noted that the advantages of the invention are also obtained when the radial distance of the outer wall 68 from the axis A does not increase around the periphery of the housing. The increasing radial distance only adds to the functional advantages obtained by continuously increasing the width of the housing 64 around its periphery.

By continuously increasing the width of the housing 64 around its periphery, it has been found that recirculation of residue into inlet 76 is minimized if not eliminated. A range of continuous increases around the periphery may be employed and a greater increase in the width than the radial distance may be employed. It should be noted that the expansion of the radial distance is such that the bats may still function as a residue particulate mover.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A crop reside spreader comprising:
a plurality of radially extending bats mounted for rotational movement about an axis A for moving residue; and
a housing surrounding the bats and having an inlet for residue adjacent the axis A and a radially outward outlet,
wherein the housing has a width measured in a direction parallel to the axis A that increases from a minimum width adjacent the outlet around its periphery up to the outlet.

2. The crop residue spreader as claimed in claim 1, wherein the housing comprises an outer wall continuously increasing in radial distance from the axis A.

3. The crop residue spreader as claimed in claim 1, wherein the housing comprises a lower planar floor and an upper wall configured so that the width continuously increases around the periphery of the housing up to the outlet.

4. The crop residue spreader as claimed in claim 1, wherein the width has a greater increase around the periphery of the housing than the radial distance.

5. The crop residue spreader according to claim 1, wherein the housing comprises an outer wall and an upper wall comprising a flat surface, wherein the outer wall is curved around the periphery.

6. The crop residue spreader as claimed in claim 5, wherein the upper wall further comprises a circular inlet shaped with a conical section tapered in a direction of flow of residue into the crop residue spreader.

7. The crop residue spreader as claimed in claim 6, further comprising a motor for driving the bats.

8. The crop residue spreader as claimed in claim 7, wherein the bats have flexible outer portions.

9. A combine harvester comprising:
a crop processing system for separating crop material from crop residue and for discharging crop residue; and
a crop residue spreader for receiving the crop residue from the crop processing system, the crop residue spreader comprising:
a plurality of radially extending bats mounted for rotational movement about an axis A for moving residue; and
a housing surrounding the bats and having an inlet for residue adjacent the axis A and a radially outward outlet,
wherein the housing has a width measured in a direction parallel to the axis A that increases from a minimum width adjacent the outlet around its periphery up to the outlet.
